(19) United States
(12) Patent Application Publication
(10) Pub. No.: US 2004/0012951 A1
(43) Pub. Date: Jan. 22, 2004

(54) Fire safety window

(76) Inventors: Russell John Pylkki, St. Paul, MN (US); Tyler Leighton Moersch, Minneapolis, MN (US); Darrel Kenneth Rhea, Redwood City, CA (US); Alex W.K. Tan, Eindhoven (NL); Marko Macura, Eindhoven (NL)

Correspondence Address: Keats A. Quinalty, Esq., Womble Carlyle Sandridge & Rice, PLLC, P O Box 7037, Atlanta, GA, 30357-0037, US

(21) Appl. No.: 10/360,560

(22) Filed: Feb. 6, 2003

Related U.S. Application Data
(63) Continuation-in-part of application No. 10/328,369, filed on Dec. 23, 2002.
(60) Provisional application No. 60/386,207, filed on Feb. 6, 2002.

(51) Int. Cl. F21S 8/00

(52) U.S. Cl. 362/152; 362/276; 340/628

(57) ABSTRACT

A window unit that includes a window frame defining a frame perimeter and a glazing unit located within the frame perimeter. A window illumination element is on the glazing unit and produces an illuminated visual indicator in response to an activating signal. The activating signal may come from a smoke alarm or other alarm system. The window unit may also include additional illumination elements on the window frame or above the window and a speaker that responds to the activating signal.

### RELATED PATENT APPLICATION

This application is a continuation in part of U.S. application Ser. No. 10/328,369, titled Fire Safety Window, filed Dec. 23, 2002, which claims priority to provisional patent application No. 60/386,207, filed Feb. 6, 2002, which applications are hereby incorporated by reference herein.

### BACKGROUND OF THE INVENTION

The invention generally relates to window units that provide egress indicators for escape from a structure during a fire and or smoke event. Egress indicators may include, for example, illumination devices and audio devices, and the like.

In case of a fire in a building, the occupants of a building need to be able to escape, often through the windows of the building. This can be a problem, because windows may be hard to locate in a fire and/or smoky room, and it may be hard to locate the window hardware to unlock and to open the window for egress.

### SUMMARY OF THE INVENTION

In accordance with the present invention, there is provided a window unit that includes a window frame defining a frame perimeter and a glazing unit located within the frame perimeter. An illumination element is on the glazing unit and produces an illuminated visual indicator in response to an activating signal. The activating signal may come from a smoke alarm or other alarm signal.

The window unit may also include a second illumination element disposed on window hardware, the window frame or above the window. The second illumination element also responds to the activating signal. The window can also include a speaker that also responds to the activating signal.

Also in accordance with the present invention, there is provided a method that includes providing a window frame defining a frame perimeter and providing a glazing unit within the frame perimeter. The method includes positioning a window illumination element disposed on the glazing unit where the window illumination element produces an illuminated visual indicator in response to an activating signal

### BRIEF DESCRIPTION OF THE DRAWINGS

FIG. 1 is a perspective view of a window unit in accordance with the invention.

FIG. 2 is a perspective view of the window unit shown in FIG. 1 responding to an activation signal.

FIG. 3 is a perspective exterior view of a window unit installed in a structure in accordance with the invention.

FIG. 4 is a perspective exterior view of the window unit shown in FIG. 3 responding to an activation signal.

FIG. 5 is a front view of a glass unit that may be used with a window unit of the invention.

FIG. 6 is a front view of an alternate embodiment of a glass unit that may be used with a window of the invention.

FIG. 7 is a cross-sectional view of a glass unit that may be used with the window of the invention.

### DETAILED DESCRIPTION OF THE PREFERRED EMBODIMENT

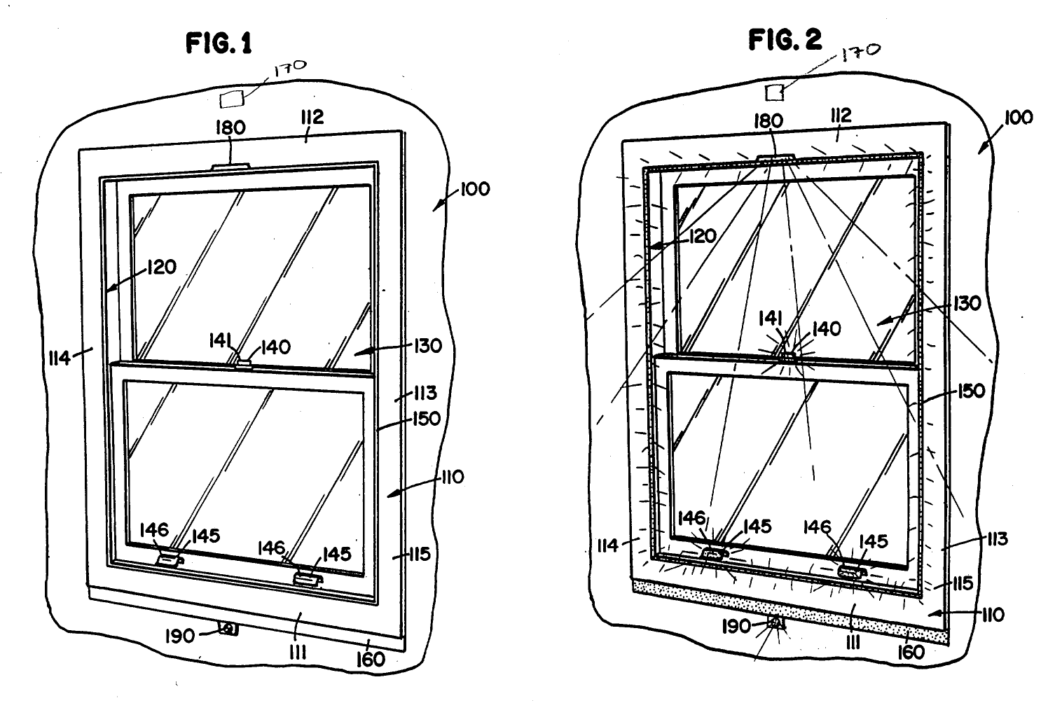

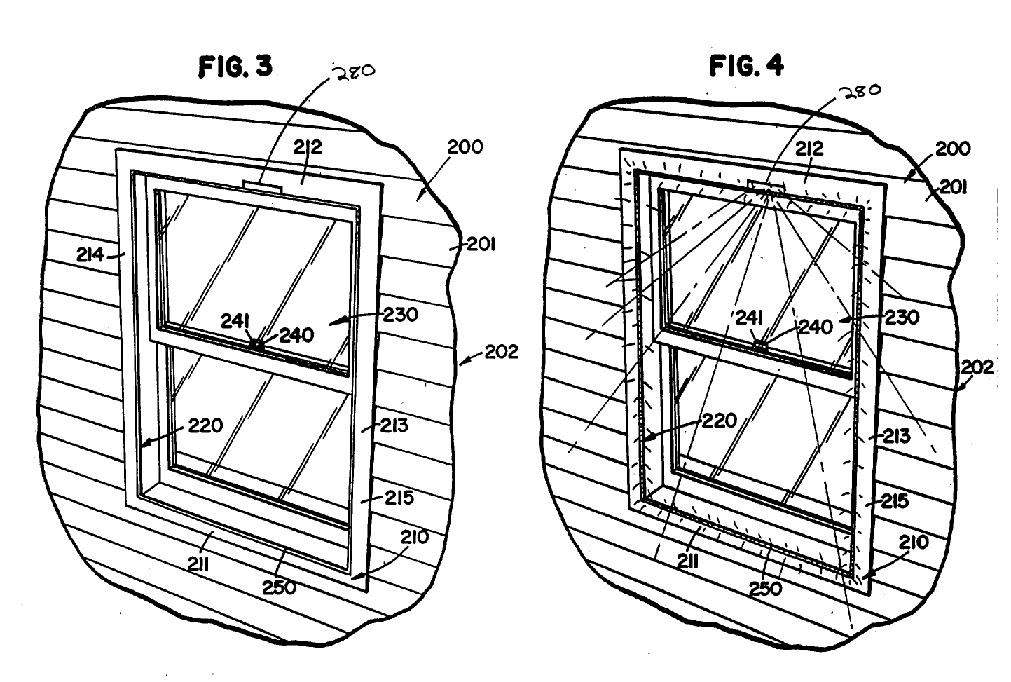

FIG. 1 is a perspective view of a window unit 100 in accordance with the invention. The window unit 100 includes a window frame 110. The window frame 110 defines a window frame perimeter 120. A glazing unit 130 is located within the frame perimeter 120. A sash may also be included surrounding the glazing unit to allow the window unit to move to a venting position. The window unit 100 can include a window frame 110 having an interior surface 115 (see FIGS. 1 and 2) and a window frame 210 having an exterior surface 215 (see FIGS. 3 and 4). The window frame 110 may include a sash frame, a casement frame or a frame surrounding window glass or sash frame or casement frame.

The window frame 110 may include two pair of opposing frame members. A first pair of opposing frame members includes a bottom frame member 111 and a top frame member 112 can be oriented along a horizontal rigid frame axis. A second pair of opposing rigid frame members includes a first side frame member 113 and a second side frame member 114 can be oriented along a vertical frame axis. The four frame members 111, 112, 113, 114 can generally form a square or rectangle shape. However, the window frame may be any shape.

The window unit 100 may be, for example, an opening in a wall or building for admission of light and air that may be closed by casements or sashes containing transparent, translucent or opaque material and may be capable of being opened or closed, such as, for example, a picture window, a bay window, a double-hung window, a skylight, egress window, an awning window, a casement window, a gliding window, and the like.

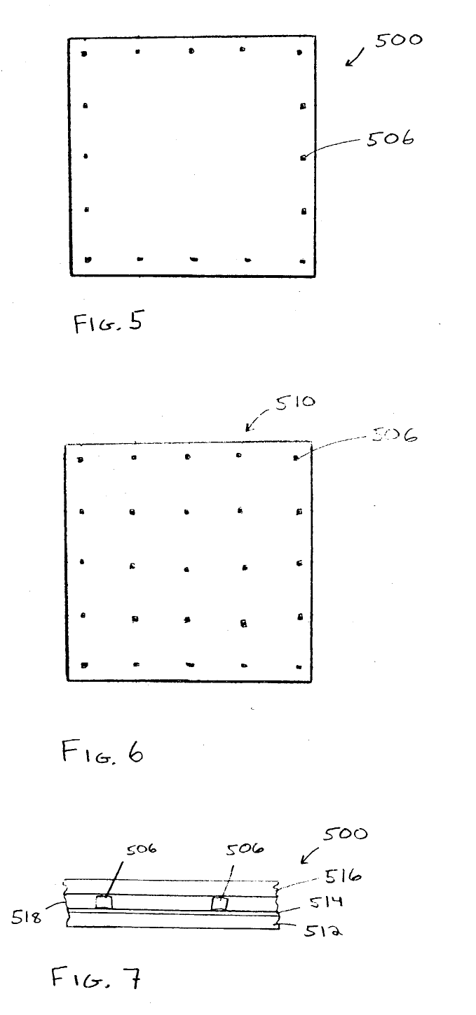

The window 100 can include illumination elements 141, 146, 150, 160. Illumination elements may be positioned on window hardware such as lock 140 and handles 145. Window hardware 140, 145 may include, for example, locks, handles, knobs, and the like. Illumination elements can also be positioned on the glass or other glazing within the window frame 110, as described further herein with reference to FIGS. 5-7. Illumination elements 141, 146 may include, for example, light emitting diodes, liquid crystal displays, electro luminescent strips, and the like.

A frame perimeter illumination element 150 can be disposed on a portion of, or the entire the frame perimeter 120. A lower illumination element 160 can be located along a bottom frame member 111 of the window frame 110. Illumination elements may include, for example, light emitting diodes, liquid crystal displays, electro luminescent strips, and the like.

The frame perimeter illumination element 150, lower illumination element 160 and window hardware illumination element 141, 146 may blend with the window unit 100, such that the frame perimeter illumination element 150, lower illumination element 160 and window hardware illumination element 141, 146 are not readily observable. The frame illumination element 150, lower illumination element 160 and window hardware illumination element 141, 146 may be a transparent or translucent material or may match the color of the window unit 100, window frame 110 or window hardware 140, 145.

The frame perimeter illumination element 150, lower illumination element 160 and window hardware illumination element 141, 146 can be in electrical connection with an alarm system such as, for example, a household smoke/fire alarm system. The alarm system can provide an activating signal to illuminate the frame perimeter illumination element 150, lower illumination element 160 and window hardware illumination element 141, 146 and produce an illuminated visual indicator. The activating signal can be, for example, an electrical signal or a mechanical signal.

The alarm system may be part of a network of sensors and alarm devices or the alarm system may be a fire and/or smoke detector 170 adjacent the window unit 100. The fire and/or smoke detector 170 may be in electrical connection to a network of sensors and alarm devices or the fire and/or smoke detector 170 may act independently. Preferably the fire or smoke detector is located on or near to the ceiling for most effective detection of heat and smoke. The frame perimeter illumination element 150, lower illumination element 160 and window hardware illumination element 141, 146 may be in electrical connection with a battery or wired directly to an electrical system. If wired to an electrical system, the electrical system may include a backup battery so that electricity would continue to operate the frame perimeter illumination element 150, lower illumination element 160 and window hardware illumination element 141, 146 in a power outage event.

The window unit 100 may also include a light 180. The light 180 can be a strobe light, a halogen light, an incandescent light, and the like. The light 180 can produce an illuminated visual indicator. The light can be located anywhere on the window frame 110. The light 180 may be recessed within the window frame 110 or flush with a surface of the window frame 110 or extend beyond the window frame 110.

The light 180 may blend with the window unit 100, such that the light 180 is not readily observable. The light 180 may be a transparent or translucent material or may match the color of the window frame 110 or window hardware 140, 145.

The light 180 can be in electrical connection with an alarm system such as, for example, a household smoke/fire alarm system. The alarm system can provide an activating signal to illuminate the light 180 and produce an illuminated visual indicator. The activating signal can be, for example, an electrical signal.

The alarm system may be part of a network of sensors and alarm devices or the alarm system may be a fire and/or smoke detector 170 adjacent the window unit 100. The fire and/or smoke detector 170 may be in electrical connection to a network of sensors and alarm devices or the fire and/or smoke detector 170 may act independently. The light 180 may be in electrical connection with a battery or wired directly to an electrical system. If wired to an electrical system, the electrical system may include a backup battery so that electricity would continue to operate the light 180 in a power outage event.

The window unit may also include a speaker element 190. The speaker element 190 can produce an audible indicator in response to an activating signal. The audible alarm may use any number of different tones, including a buzzer, a gong-like tone, a beeping tone, a siren sound, or it could also utilize a recorded human voice. The recorded human voice could be a person giving pre-recorded instructions, or the user could customize it, so the pre-recorded voice is the sound of a child's parent giving them instructions to come toward the sound of the voice.

The speaker element 190 can be located anywhere on the window frame 110. The speaker element 190 may be recessed within the window frame 110 or flush with a surface of the window frame 110 or extend beyond the window frame 110. The speaker element may be adjacent to the window frame 110, such as adjacent to and below the bottom frame member 111.

The speaker element 190 may blend with the window unit 100, such that the speaker element 190 is not readily observable. The speaker element 190 may be a transparent or translucent material or may match the color of the window unit 100, window frame 110 or window hardware 140, 145. Alternatively, the speaker element may be incorporated in the glass of the window, where a speaker exciter element is attached to the glass and causes the glass to act as a speaker.

The speaker element 190 can be in electrical connection with an alarm system such as, for example, a household smoke/fire alarm system. The alarm system can provide an activating signal to activate the speaker element 190 and produce an illuminated visual indicator. The activating signal can be, for example, an electrical signal.

The alarm system may be part of a network of sensors and alarm devices or the alarm system may be a fire and/or smoke detector 170 adjacent the window unit 100. The fire and/or smoke detector 170 may be in electrical connection to a network of sensors and alarm devices or the fire and/or smoke detector 170 may act independently. The speaker element 190 may be in electrical connection with a battery or wired directly to an electrical system. If wired to an electrical system, the electrical system may include a backup battery so that electricity would continue to operate the speaker element 190 in a power outage event.

FIG. 2 is a perspective view of the window shown in FIG. 1 responding to an activation signal. The frame perimeter illumination element 150, lower illumination element 160, window hardware illumination element 141, 146 and light 180 are shown in an activated state. The speaker element 190 is also shown in an activated state.

FIG. 3 is a perspective view of a window 200 installed in a structure in accordance with the invention. The window 200 may be installed in an opening in siding 201 of a structure 202. The window unit 200 includes a window frame 210. The window frame 210 defines a window frame perimeter 220. A glazing unit 230 is located within the frame perimeter 220. A sash may also be included surrounding the glazing unit to allow the window unit to move to a venting position.

The window frame 210 may include two pair of opposing frame members. A first pair of opposing frame members includes a bottom frame member 211 and a top frame member 212 can be oriented along a horizontal rigid frame axis. A second pair of opposing rigid frame members includes a first side frame member 213 and a second side frame member 214 can be oriented along a vertical frame axis. The four frame members 211, 212, 213, 214 can generally form a square or rectangle shape. However, the window frame may be any shape.

The window unit 200 may be, for example, an opening in a wall or building for admission of light and air that may be closed by casements or sashes containing transparent, translucent or opaque material and may be capable of being opened or closed, such as, for example, a picture window, a bay window, a double-hung window, a skylight, egress window, an awning window, a casement window, a gliding window, and the like.

The window 210 can include illumination elements 241, 250. A frame perimeter illumination element 250 can be disposed on a portion of, or the entire the frame perimeter 220. Illumination elements may include, for example, light emitting diodes, liquid crystal displays, electro luminescent strips, and the like.

The frame perimeter illumination element 250 may blend with the window unit 200, such that the frame perimeter illumination element 250 is not readily observable. The frame illumination element 250 may be a transparent or translucent material or may match the color of the window unit 200 or window frame 210.

The frame perimeter illumination element 250 can be in electrical connection with an alarm system such as, for example, a household smoke/fire alarm system. The alarm system can provide an activating signal to illuminate the frame perimeter illumination element 250 and produce an illuminated visual indicator. The activating signal can be, for example, an electrical signal.

The alarm system may be part of a network of sensors and alarm devices or the alarm system may be a fire and/or smoke detector 170 (see FIGS. 1 and 2) adjacent the window unit 200. The fire and/or smoke detector 170 may be in electrical connection to a network of sensors and alarm devices or the fire and/or smoke detector 170 may act independently. The frame perimeter illumination element 250 may be in electrical connection with a battery or wired directly to an electrical system. If wired to an electrical system, the electrical system may include a backup battery so that electricity would continue to operate the frame perimeter illumination element 250 in a power outage event.

The window unit 200 may also include a light 280. The light 280 can be a strobe light, a halogen light, an incandescent light, and the like. The light 280 can produce an illuminated visual indicator. The light can be located anywhere on the window frame 210. The light 280 may be recessed within the window frame 210 or flush with a surface of the window frame 210 or extend beyond the window frame 210.

The light 280 may blend with the window unit 200, such that the light 280 are not readily observable. The light 280 may be a transparent or translucent material or may match the color of the window unit 200, window frame 210 or window hardware 240, 245.

The light 280 can be in electrical connection with an alarm system such as, for example, a household smoke/fire alarm system. The alarm system can provide an activating signal to illuminate the light 280 and produce an illuminated visual indicator. The activating signal can be, for example, an electrical signal.

The alarm system may be part of a network of sensors and alarm devices or the alarm system may be a fire and/or smoke detector 170 (see FIGS. 1 and 2) adjacent the window unit 200. The fire and/or smoke detector 170 may be in electrical connection to a network of sensors and alarm devices or the fire and/or smoke detector 170 may act independently. The light 280 may be in electrical connection with a battery or wired directly to an electrical system. If wired to an electrical system, the electrical system may include a backup battery so that electricity would continue to operate the light 280 in a power outage event.

FIG. 4 is a perspective view of the window shown in FIG. 3 responding to an activation signal. The frame perimeter illumination element 250 and light 280 are shown in an activated state.

FIG. 5 illustrates a glass unit 500 that may be used within a window unit like the window units shown in FIGS. 1-4. The glass unit 500 includes small light emitting diodes (LEDs) 506 adhered to the glass. The LEDs 506 may be powered by a transparent conductive layer on the glass and may be connected to an alarm system or smoke detector, as discussed above, to activate the LEDs when smoke is detected. The system could be designed to cause the LEDs 506 to light up continuously, flash, or flash in a specific manner when an activating signal is received. The LEDs 506 make window exits more obvious to building occupants and emergency workers when illuminated. The LEDs 506 may be fairly small so that they are not readily apparent to a casual observer. For example, the LEDs may be rectangular in shape with a maximum dimension of about 1 cm or less. Preferably, the LEDs have a maximum dimension of about 5 mm or less more preferably about 3 mm or less. For example, the LEDs may be rectangular with dimensions of about 3 mm by about 2 mm. In FIG. 5, the LEDs are positioned along the border of the glass unit, so that the LEDs 506 are fairly unobtrusive to the overall transparency of and view through the glass unit. A larger area of the glass unit results in the LEDs being less apparent along the border.

In FIG. 6, an alternate glass unit 510 is shown including a matrix of LEDs 506 that may be used within a window unit like the window units shown in FIGS. 1-4. The LEDs 506 may operate as discussed above in relation to FIG. 5. Either the LED configuration of FIG. 5 or 6 may be used as the only illumination element in a window unit and alarm system combination, or may be used in combination with one or more other illumination elements on the window frame, window hardware or near the window unit such as a flood light or strobe light. Examples of other illumination elements that can be included are discussed in relation to FIGS. 1-4. LEDs may alternatively be arranged in many different patterns on the glass, such as in the shape of an arrow, a message, or other shapes. In one alternate embodiment, the LEDs may be individual controlled so that the illuminated pattern can be varied using a computer processor attached to the LEDs. It is also possible to use LEDs that are capable of emitting light of one of a few different colors.

FIG. 7 shows a cross sectional view of a small portion of a glass unit 500 or 510 including LEDs 506. A base glass layer 512 is coated with a transparent conductive layer 514 formed into conductive paths. LEDs 506 are physically attached and electrically connected to the transparent conductive layer 514. The layers of FIG. 7 are not drawn to scale so that the components may be more easily illustrated. A cover glass layer 516 may be provided to protect the LEDs and provide a smooth outer surface to the glass unit. The area between the glass layers may be filled with a transparent resin material 518. Alternatively, the cover glass layer 516 may be spaced from and sealed to the base glass layer 512 with an insulating gas between the layers to provide an insulated glass unit. Alternatively, a third glass layer could be spaced from and sealed to the glass unit to provide an insulated glass unit.

Glass units 500 or 510 may be obtained commercially from Glas Platz in Wiehl, Germany under the trade name “power glass” or from Schott Desag of Mainz, Germany under the trade name “LightPoints.”

A window 100 may be constructed by providing a window frame 110 defining a frame perimeter 120 and providing a glazing unit 130 located within the frame perimeter 120. A window illumination element such as LED 506 may be positioned disposed on the glazing unit where the window illumination element produces an illuminated visual indicator in response to an activating signal. Additional illumination elements may also be positioned on the window unit as discussed above.

We claim:

1. A window unit comprising:
(a) a window frame defining a frame perimeter;
(b) a glazing unit located within the frame perimeter; and
(c) a first window illumination element disposed on the glazing unit; wherein the window illumination element produces an illuminated visual indicator in response to an activating signal.

2. The window unit of claim 1 wherein the first window illumination element is a plurality of LEDs attached to the glazing unit.

3. The window unit of claim 2 wherein the plurality of LEDs are positioned along the outer border of the glazing unit.

4. The window unit of claim 2 wherein the plurality of LEDs are positioned in a matrix on the glazing unit.

5. The window unit of claim 2 wherein each of the plurality of LEDs has a largest dimension of about 1 cm or less.

6. The window unit of claim 1 further comprising a second window illumination element disposed on the window frame.

7. The window unit of claim 6 further comprising window hardware, wherein the second window illumination element is positioned on the window hardware.

8. The window unit of claim 6 wherein, the second window illumination element is disposed on the window frame perimeter.

9. The window unit of claim 6 wherein, the second window illumination element is electro luminescent strips.

10. The window unit of claim 6 wherein, the second illumination element is disposed along the entire frame perimeter.

11. The window unit of claim 1 further comprising a speaker element, disposed on or adjacent to the window frame, to produce an audible indicator in response to the activating signal.

12. The window unit of claim 1 further comprising a light disposed on the window frame to produce an illuminated visual indicator in response to the activating signal.

13. The window unit of claim 12 wherein, the light is a strobe light.

14. The window unit of claim 1 wherein, the window frame has an exterior surface defining an exterior frame perimeter and an interior surface defining an interior frame perimeter.

15. The window unit of claim 14 wherein, the second illumination element is disposed on the interior frame perimeter.

16. The window unit of claim 14 wherein, the second illumination element is disposed on the exterior frame perimeter.

17. The window unit of claim 14 wherein, the second illumination element is disposed on the interior frame perimeter and further comprising a third illumination element disposed on the exterior frame perimeter.

18. The window unit of claim 14 further including, a light disposed in the window frame interior surface to produce an illuminated visual indicator in response to the activating signal.

19. The window unit of claim 14 further including, a light disposed in the window frame exterior surface to produce an illuminated visual indicator in response to the activating signal.

20. The window unit of claim 14 further including, a first light disposed on the window frame exterior surface and a second light disposed on the window frame interior surface, wherein the first and second lights produce an illuminated visual indicator in response to the activating signal.

21 A method comprising:
(a) providing a window frame defining a frame perimeter;
(b) providing a glazing unit within the frame perimeter;
(c) positioning a window illumination element disposed on the glazing unit;
wherein the window illumination element produces an illuminated visual indicator in response to an activating signal.
